(19) United States
(12) Patent Application Publication
(10) Pub. No.: US 2026/0151918 A1
(43) Pub. Date: Jun. 4, 2026

(54) CLEANING TOOL FOR BENDING MACHINES

(71) Applicant: TRUMPF Maschinen Austria GmbH & Co. KG., Pasching (AT)

(72) Inventors: Hannes FOSTEL, Linz (AT); Alois AUSTALLER, Roitham (AT)

(73) Assignee: TRUMPF Maschinen Austria GmbH & Co. KG., Pasching (AT)

(21) Appl. No.: 19/121,855

(22) PCT Filed: Oct. 18, 2023
(86) PCT No.: PCT/AT2023/060359

§ 371 Date: Apr. 17, 2025

(30) Foreign Application Priority Data
Oct. 18, 2022 (AT) A8004/2023
Oct. 18, 2022 (AT) GM50160/2022

(51) Int. Cl. B25J 11/00; B08B 1/12; B08B 1/30; B08B 5/04; B21D 37/00

(52) U.S. Cl. CPC B25J 11/0085; B08B 1/12; B08B 1/30; B08B 5/04; B21D 37/00

(57) ABSTRACT

A cleaning tool for at least a part of the lower tool arrangement of bending machines with an automation system or robot grippers includes at least one brush and a suction arrangement with a receiving container material removed by suction. The cleaning tool is equipped with a coupling arrangement for the automation system or the robot gripper, and the suction arrangement can be coupled to a compressed air system of the automation system or robot gripper. A bending machine with an automation system or robot grippers and such a cleaning tool can have this cleaning tool coupled to the automation system and/or the robot gripper or the cleaning tool is held ready for coupling to the automation system and/or the robot gripper.

The invention relates to a cleaning tool for at least a part of the lower tool arrangement of bending machines with an automation system or robot grippers.

The Japanese publication JPS6033828A already describes an automatic cleaning of a lower tool of a bending press. In this regard, a gear-driven cleaning carriage with a rotating brush moves along the bending surface and cleans it. However, no provisions are made for automatic handling by a gripper, and it is not the holder for the bending tool that is cleaned, but the surface of the tool itself.

Japanese publication JP2013237075A discloses a cleaning carriage with rigid cleaning brushes that can be handled by means of an automation system, which cleaning carriage automatically moves along and cleans the receptacle for the lower tool of a bending press after being set down. The dirt adhering to the brushes is blown away by means of compressed air.

Furthermore, a system from the company Bystronic is known in which automatic cleaning is provided for the holder of the lower tool. In this regard, a cleaning tool that can be moved by means of the robot gripper cleans the holder for the lower tool of the bending press using compressed air, but without providing any brushes.

JP2005319351A discloses an arrangement in which a freely programmable robot carries a detachable cleaning unit for a die of a sheet metal processing machine. The cleaning unit has a brush, which may also be mounted to rotate, and a suction element for the detached contaminants, which are then transported into a collecting container and collected there.

The object of the present invention was to overcome the shortcomings of the prior art and to provide a device and a method the structure of which is simple and flexible and which is optimally suited for integration into the automation system of the bending machines and/or for connection to a robot used for this purpose.

This object is achieved by a device according to the claims.

The device according to the invention provides a cleaning tool for this purpose, which comprises at least one brush for the lower tool and/or the lower tool holder, as well as a compressed air-operated suction arrangement with a receiving container for sucked-off material, wherein the cleaning tool is equipped with a coupling arrangement for the automation system or the robot gripper. The suction arrangement can be coupled to a compressed air system of the automation system or robot gripper. This enables automatic scale and dust removal from the lower tool clamp and the lower tools using a device with an integrated air-driven vacuum cleaner with brush attachment.

A cleaning tool with a receiving container configured as a collection bag made of textile, air-permeable material is preferred in this regard.

Advantageously, a filter arrangement can be arranged in the suction arrangement upstream of a vacuum connection.

A simple embodiment of a cleaning tool according to the invention is characterized in that at least one brush is rigidly integrated into and/or mounted on the cleaning tool.

Another embodiment provides that at least one rotating brush is integrated into and/or mounted on the cleaning tool and can preferably be driven by means of the compressed air system of the automation system or robot gripper.

Preferably, the width of at least one brush corresponds in each case to the width of the lower tool and/or the lower tool holder.

A bending machine with an automation system or robot grippers and a cleaning tool is also provided for achieving the object at hand and is equipped with at least one brush for the lower tool and/or the lower tool holder for this purpose. In this regard, a cleaning tool according to one of the preceding paragraphs is coupled to the automation system and/or the robot gripper or is held ready for coupling with the automation system and/or the robot gripper.

In this regard, it is preferably provided that the cleaning tool can be moved by the automation system and/or the robot gripper along a trajectory that can be freely programmed in the automation system and/or the robot gripper.

Furthermore, it can advantageously be provided that an instruction block is implemented in the automation system and/or in a controller for the robot gripper, in order to move the cleaning system along a straight line parallel to and with the brush brushing along the lower tool and/or the lower tool holder.

Preferably, a tool magazine or a tool-changing station is configured to receive and to hold ready the cleaning tool.

For the purpose of better understanding of the invention, it will be elucidated in more detail by means of the figures below.

These show in a respectively very simplified schematic representation:

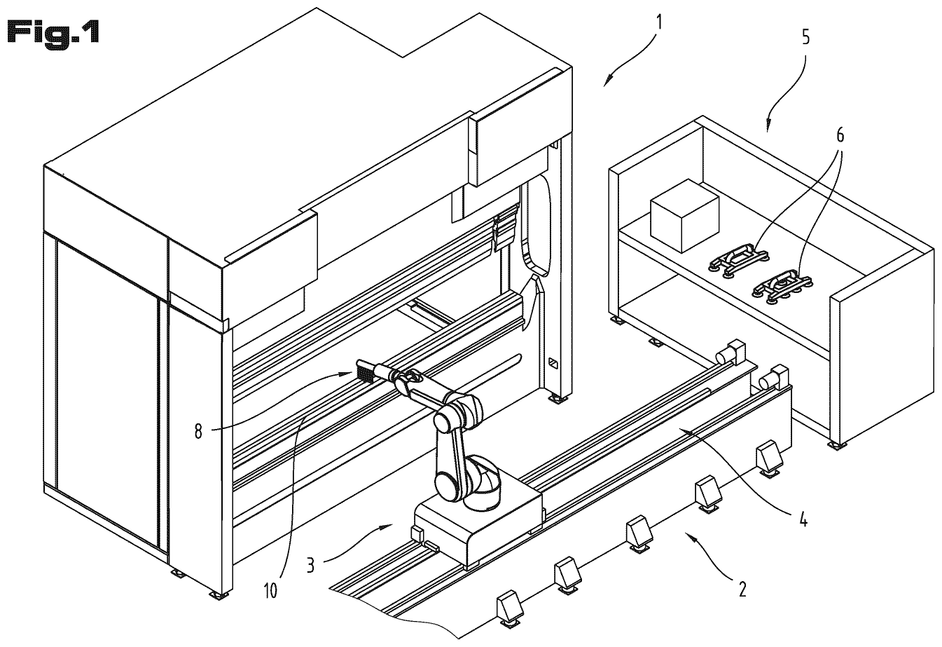

FIG. 1 a complete view of a bending machine, a robot with an attached cleaning device and a changing station;

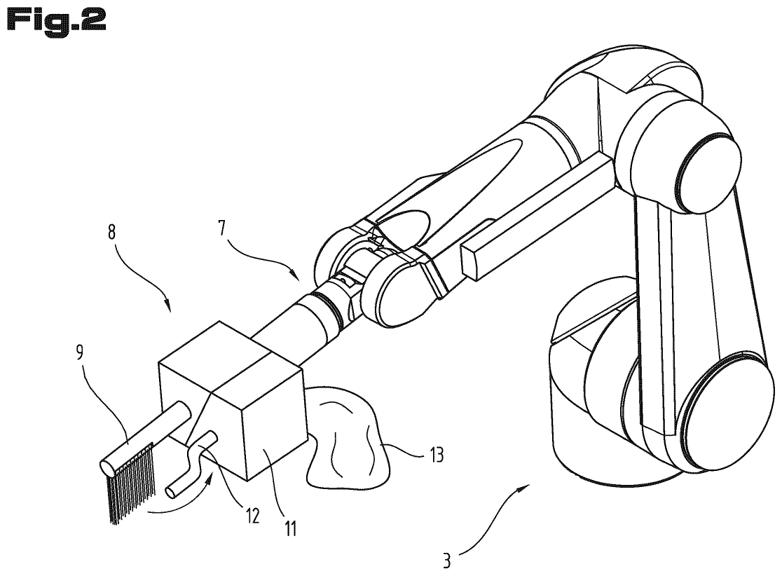

FIG. 2 an enlarged view of a robot with an attached cleaning device;

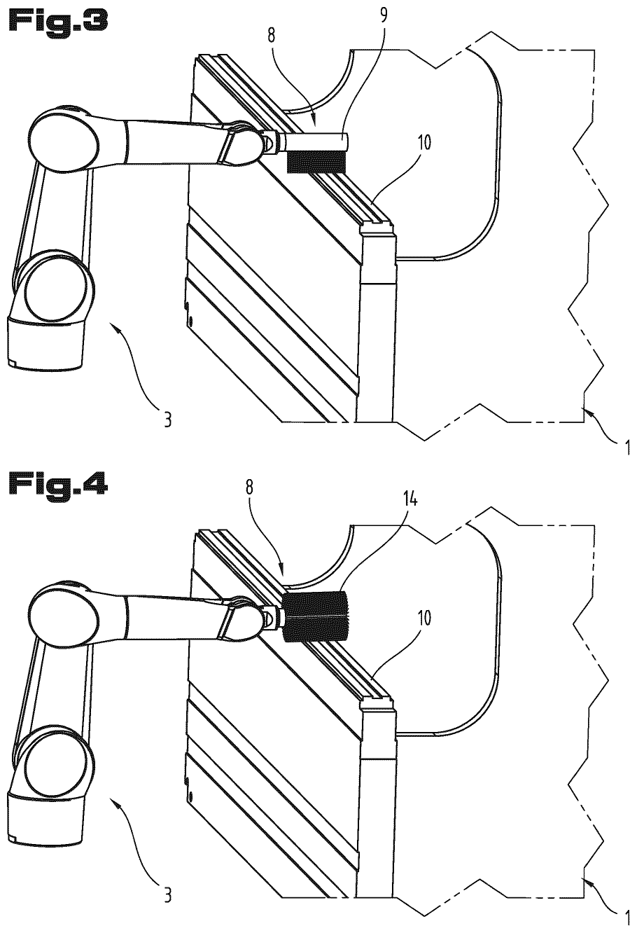

FIG. 3 an enlarged view of a robot with an attached cleaning device with a rigid brush;

FIG. 4 an enlarged view of a robot with a coupled cleaning device with a rotating brush.

First of all, it is to be noted that in the different embodiments described, equal parts are provided with equal reference numbers and/or equal component designations, where the disclosures contained in the entire description may be analogously transferred to equal parts with equal reference numbers and/or equal component designations. Moreover, the specifications of location, such as at the top, at the bottom, at the side, chosen in the description refer to the directly described and depicted figure and in case of a change of position, these specifications of location are to be analogously transferred to the new position. For ease of understanding of the structure, elements can partially not be depicted to scale and/or be enlarged and/or be reduced in size.

FIG. 1 shows a schematic complete view of an arrangement with a bending machine 1 with an automation system 2, in particular here in the form of a system with a robot gripper 3, which is advantageously movable along a guide track 4 along the bending machine 1. Preferably, furthermore, a tool magazine and/or a tool-changing station 5 for receiving and providing different tools 6 for the bending machine 1 is positioned in the working area of the robot gripper 3, either stationarily or, if necessary, movable for simple and quick replacement.

As indicated in FIG. 1 and shown on a larger scale in FIG. 2, a cleaning tool 8 can also be coupled to the tool coupling 7 of the robot gripper 3 in addition to grippers for diverse tools 6. The cleaning tool 8 is equipped with at least one brush 9 for the lower tool and/or the lower tool holder 10. Furthermore, a compressed air-operated suction arrangement 11 is detachably coupled to the robot gripper 3 and preferably integrated into the cleaning tool 8. For this purpose, the cleaning tool 8 is equipped with a coupling arrangement for the automation system or the robot gripper.

Lastly, a suction pipe 12 leads to a receiving container 13 for sucked-off material. This receiving container 13 is preferably configured as a collection bag made of textile, air-permeable material. The suction arrangement 11 can be coupled to a compressed air system of the automation system or robot gripper 3. Advantageously, a filter arrangement can be arranged in the suction arrangement upstream of a vacuum connection.

As shown in FIGS. 1 to 3, the cleaning tool 8 can be equipped with at least one rigidly integrated and/or mounted brush 9. Alternatively, as shown in FIG. 4, at least one rotating brush 14 can also be integrated into and/or mounted on the cleaning tool 8. Such a rotating brush 14, which is also moved by means of the robot gripper 3, is preferably embodied to be drivable by means of the compressed air system of the automation system or robot gripper 3. In any case, the width of at least one brush 9, 14 preferably corresponds to the width of the lower tool and/or the lower tool holder 10 of the bending machine 1.

In the same way as it is configured for the tools 6, the cleaning tool 8 can also be kept ready in the tool-changing station 4 and can also be put away again after use. Preferably, the cleaning tool 8 can be moved by the automation system and/or the robot gripper 3 along a trajectory that can be freely programmed in the automation system and/or the robot gripper 3. For this purpose, for example, an instruction block is implemented in the automation system and/or in a controller for the robot gripper 3, in order to move the cleaning system 8 along a straight line parallel to and with the brush 9, 14 brushing along the lower tool and/or the lower tool holder 10.

Preferably, at least the suction device 11 is activated by switching on the compressed air and the tool clamping of the lower tools is cleaned just by movement along the bending machine 1. This has the great advantage that the respective lower tool is not pulled over scale and therefore no increased wear of the clamping and/or inaccuracies in the height of the lower tool occur. Furthermore, aggressive scale is no longer dragged into plastic guides, for example, so that these are protected against damage. Lastly, the existing set-up can at the same time also be cleaned in advance.

The exemplary embodiments show possible embodiment variants, and it should be noted in this respect that the invention is not restricted to these particular illustrated embodiment variants of it, but that rather also various combinations of the individual embodiment variants are possible and that this possibility of variation owing to the technical teaching provided by the present invention lies within the ability of the person skilled in the art in this technical field.

### List of Reference Numbers

1 Bending machine
2 Automation system
3 Robot gripper
4 Guide
5 Tool-changing station
6 Tool
7 Coupling
8 Cleaning device
9 Brush (rigid)
10 Lower tool holder
11 Suction device
12 Suction pipe
13 Receiving container
14 Brush (rotating)

1: A cleaning tool (8) for at least a part of the lower tool arrangement of bending machines (1) with an automation system (2) or robot grippers (3), the cleaning tool (8) comprising at least one brush (9, 14) for the lower tool and/or the lower tool holder (10), as well as a compressed air-operated suction arrangement (11) with a receiving container (13) for sucked-off material, wherein the cleaning tool (8) is equipped with a coupling arrangement for the automation system (2) or the robot gripper (3),
wherein
the suction arrangement (11) can be coupled to a compressed air system of the automation system (2) or robot gripper (3).

2: The cleaning tool according to claim 1,
wherein the receiving container (13) is configured as a collecting bag made of textile, air-permeable material.

3: The cleaning tool according to claim 1,
wherein a filter arrangement is arranged in the suction arrangement (11) upstream of a vacuum connection.

4: The cleaning tool according to claim 1,
wherein at least one brush (9) is rigidly integrated into and/or mounted on the cleaning tool (8).

5: The cleaning tool according to claim 1,
wherein at least one rotating brush (14) is integrated into and/or mounted on the cleaning tool (8) and can preferably be driven using the compressed air system of the automation system (2) or robot gripper (3).

6: The cleaning tool according to claim 1,
wherein the width of at least one brush (9, 14) corresponds to the width of the lower tool and/or the lower tool holder (10).

7: A bending machine (1) with an automation system (2) or robot grippers (3) and a cleaning tool (8) with at least one brush (9, 14) for the lower tool and/or the lower tool holder (10),
the cleaning tool (8) according to claim 1 is coupled to the automation system (2) and/or the robot gripper (3) or is held ready for coupling to the automation system (2) and/or the robot gripper (3).

8: The bending machine according to claim 7,
wherein the cleaning tool (8) can be moved by the automation system (2) and/or the robot gripper (3) along a trajectory that can be freely programmed in the automation system (2) and/or the robot gripper (3).

9: The bending machine according to claim 7,
wherein an instruction block is implemented in the automation system (2) and/or in a controller for the robot gripper (3), in order to move the cleaning system (8) along a straight line parallel to and with the brush (9, 14) brushing along the lower tool and/or the lower tool holder (10).

10: The bending machine according to claim 7,
wherein a tool magazine and/or a tool-changing station (5) is configured to receive and to hold ready the cleaning tool (8).
